(19) United States
(12) Patent Application Publication
(10) Pub. No.: US 2009/0160192 A1
(43) Pub. Date: Jun. 25, 2009

(54) Circulating hydroelectricity generating and energy storing apparatus

(76) Inventor: Shou-Hsiung Chen, Taipei City (TW)

Correspondence Address: Shou-Hsiung Chen, P.O. Box 46-563 Taipei, Taipei City, 10499, TW

(21) Appl. No.: 12/221,177

(22) Filed: Aug. 1, 2008

(30) Foreign Application Priority Data
Dec. 19, 2007 (TW) 096221609

(51) Int. Cl. F03B 13/00

(52) U.S. Cl. 290/54

(57) ABSTRACT

A circulating hydroelectricity generating and energy storing apparatus includes a carrier, a water-supply tank settled at a top of the carrier, and a water-storage tank settled at a bottom of the carrier. The carrier contains a draining channel connecting between the water-supply tank and the water-storage tank. The water-storage tank is pivotally provided with a first waterwheel that drives a water pump, wherein the water pump is connected with the water-supply tank. A generator of a hydroelectric device is settled beside the draining channel while a second waterwheel pivotally equipped to the generator has a bottom received in the draining channel. Thereby, water passing through the draining channel rotates the second waterwheel and enables the generator to generate electricity. Afterward, the water impacts the first waterwheel to drive the water pump to draw the water back to the water-supply tank so as to recycle the water used in power generation.

### BACKGROUND OF THE INVENTION

1. Technical Field

The present invention relates to hydroelectricity generating and energy storing apparatuses. More particularly, the present invention relates to a circulating hydroelectricity generating and energy storing apparatus that features circulating water used in power generation and storing energy of the generated power.

2. Description of Related Art

The known small-scale power generating apparatuses typically consume fuel such as gasoline or diesel oil as power sources. By burning the fuel, the power generation apparatuses are enabled to operate and generate electricity.

Although fuel, when used as the power sources of power generating apparatuses, facilitates production of considerable quantity of electricity in relatively short time, it tends to generate waste gas that pollutes the atmosphere. Besides, as the costs for purchasing fuel keep increasing in recent years in response to decreasing oil productivity, fuel expenses for the traditional power generating apparatuses are bound to rise.

In some alternative approaches, small-scale wind power generators or solar power generators are implemented to produce electricity. However, efficiency of such power generators is subject to the weather, so that low power productivity ensues under improper weather conditions. Another problem is that the prior art devices are usually incapable of storing energy of off-peak power in an environment-friendly manner.

Hence, researches have been conducted by relevant manufacturers and the inventor of the present invention with the attempt to improve the conventional power generating devices.

### SUMMARY OF THE INVENTION

In view of the foregoing defects of the prior art devices, the inventor of the present invention, with years of experience in the art, has conducted extensive researches as well as numerous trials, and herein proposes a circulating hydroelectricity generating and energy storing apparatus that features circulating water used in power generation and storing energy of the generated power.

A primary objective of the present is to overcome the problem with the prior art devices that their power sources are hard to obtain and non-recyclable. To accomplish this end, the present invention provides a circulating hydroelectricity generating and energy storing apparatus wherein water used in generating power is recycled. The apparatus comprises a water-supply tank and a water-storage tank positioned at a top and a bottom of a carrier, respectively. A serpentine draining channel is provided in the carrier and is connected between an outlet of the water-supply tank and an inlet of the water-storage tank. The water-storage tank is pivotally equipped with a first waterwheel that drives a water pump, wherein the water pump is further connected with an inlet of the water-supply tank.

A secondary objective of the present is to accelerate recycle of water used in power generation. To achieve this end, the aforesaid circulating hydroelectricity generating and energy storing apparatus is further provided with an external generator that is connected with the carrier so that when electricity generated by the external generator is supplied to the water pump, the water pump can operate with more electricity to prompt water recycling.

### BRIEF DESCRIPTION OF THE DRAWINGS

The technical means and the structure adopted by the present invention to achieve the above objectives and effects can be best understood by referring to the accompanying drawings wherein features and functions of preferred embodiments of the present invention are shown, in which:

FIG. 1 is a perspective view of a first preferred embodiment of the present invention;

FIG. 2 is a perspective view of a second preferred embodiment of the present invention;

FIG. 3 is a perspective view of a third preferred embodiment of the present invention;

FIG. 4 is a perspective view of a fourth preferred embodiment of the present invention;

FIG. 5 is a perspective view of a fifth preferred embodiment of the present invention;

FIG. 6 is a partially enlarged view of a preferred embodiment of the present invention; and

FIG. 7 is a schematic drawing showing an application of the present invention.

### DETAILED DESCRIPTION OF THE PREFERRED EMBODIMENTS

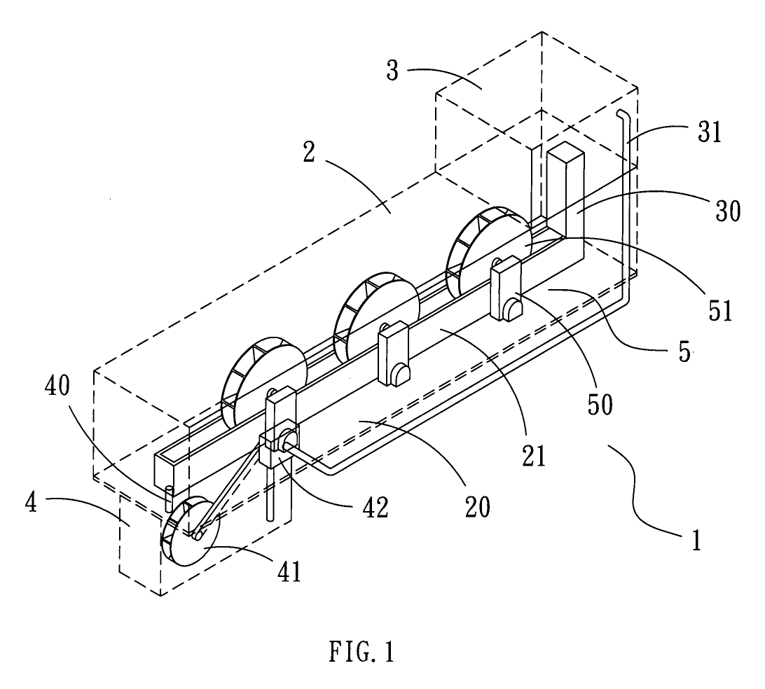

Please refer to FIG. 1 for a first preferred embodiment of the present invention. As can be seen clearly in the drawing, a circulating hydroelectricity generating and energy storing apparatus 1 comprises a carrier 2, a water-supply tank 3, a water-storage tank 4 and a hydroelectric device 5.

The carrier 2 is hollow and has a carrying board 20 settled at a bottom thereof. The carrying board 20 carries a draining channel 21. The carrier 2 may be any one of an apartment, a mansion, a building, a concrete construction and a reinforced concrete construction.

The water-supply tank 3 accommodates therein a fluid, such as water, and has an outlet 30 and an inlet 31 for draining and filling water, respectively.

The water-storage tank 4 also accommodates therein a fluid, such as water, and has an inlet 40 for filling water. Furthermore, the water-storage tank 4 is provided pivotally with a first waterwheel 41 that drives a water pump 42 for drawing the water out of the water-storage tank 4. The first waterwheel 41 and the water pump 42 may be dynamically linked by any one of a chain assembly, a gear assembly, a rotational axle assembly and a pulley assembly.

The hydroelectric device 5 is composed of a plurality of generators 50, each provided pivotally with a second waterwheel 51 that rotates to enable the corresponding generator 50 to generate electricity.

To assemble the above-recited components, the water-supply tank 3 is settled at a top of the carrier 2 while the water-storage tank 4 is settled at a bottom of the carrier 2. The draining channel 21 in the carrier 2 has one end thereof connected with the outlet 30 of the water-supply tank 3 and an opposite end connected with the inlet 40 of the water-storage tank 4.

Meanwhile, the water pump 42 of the water-storage tank 4 is in connection with the inlet 31 of the water-supply tank 3 so that the water in the water-storage tank 4 can be drawn back to the water-supply tank 3 through the inlet 31.

Moreover, the second waterwheels 51 of the hydroelectric device 5 have bottoms thereof received in the draining channel 21. Thereby, when the water in the water-supply tank 3 flows into the draining channel 21 through the outlet 30, the water flowing in the draining channel 21 drives the second waterwheels 51 to rotate, so that the rotating second waterwheels 51 enable the generators 5 to generate electricity. Afterward, the water keeps flowing forward in the draining channel 21 and eventually enters the water-storage tank 4 through the inlet 40. When pouring out from the inlet 40 of the water-storage tank 4, the water impacts and rotates the first waterwheel 41. The rotating first waterwheel 41 drives the water pump 42 to draw the water in the water-storage tank 4 back to the water-supply tank 3 through the inlet 31, thereby recycling the water used in power generation.

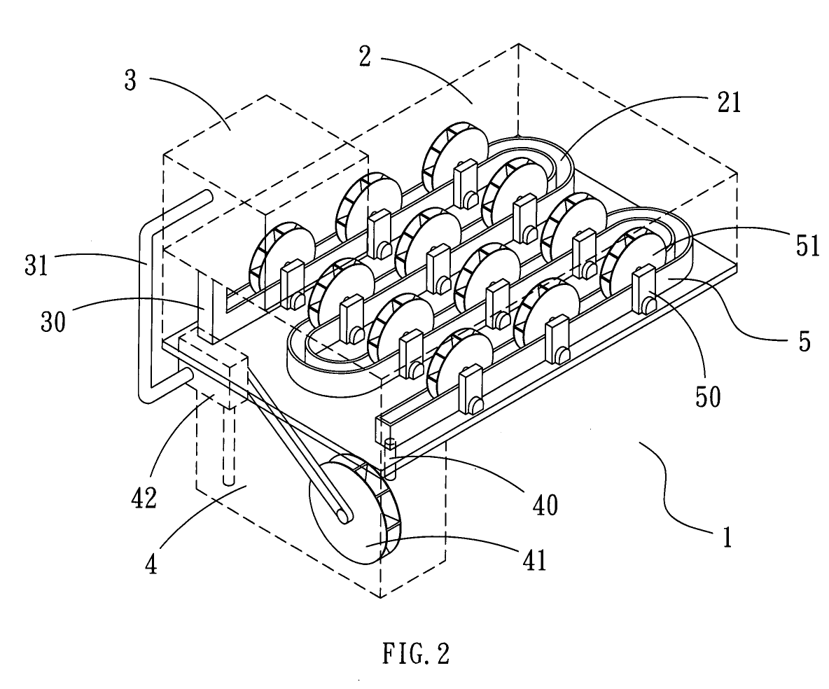

Referring to FIG. 2, according to a second preferred embodiment of the present invention, a circulating hydroelectricity generating and energy storing apparatus 1 comprises a carrier 2, a water-supply tank 3, a water-storage tank 4 and a hydroelectric device 5. The water-supply tank 3 is settled at a top of the carrier 2 while the water-storage tank 4 is settled at a bottom of the carrier 2. A serpentine draining channel 21 is provided in the carrier 2 with one end thereof connected with an outlet 30 of the water-supply tank 3 and an opposite end connected with an inlet 40 of the water-storage tank 4. The water-storage tank 4 is provided pivotally with a first waterwheel 41 that drives a water pump 42. The water pump 42 is further connected with an inlet 31 of the water-supply tank 3.

In addition, the hydroelectric device 5 is composed of a plurality of generators 50 that are arranged beside and along the serpentine draining channel 21. Each said generator 50 is provided pivotally with a second waterwheel 51 that has a bottom thereof received in the draining channel 21. When the above-recited components are assembled and in operation, water in the water-supply tank 3 flows into the draining channel 21 through the outlet 30, and the water flowing in the draining channel 21 drives the second waterwheels 51 to rotate so that the rotating second waterwheels 51 enable the generators 50 to generate electricity. Afterward, the water keeps flowing forward along the draining channel 21 and eventually enters the water-storage tank 4 through the inlet 40. When pouring out from the inlet 40 of the water-storage tank 4, the water impacts and rotates the first waterwheel 41. The rotating first waterwheel 41 drives the water pump 42 to draw the water in the water-storage tank 4 back to the water-supply tank 3 through the inlet 31, thereby recycling the water used in power generation.

The carrier 2 may be any one of an apartment, a mansion, a building, a concrete construction and a reinforced concrete construction while the first waterwheel 41 and the water pump 42 may be dynamically linked by any one of a chain assembly, a gear assembly, a rotational axle assembly and a pulley assembly.

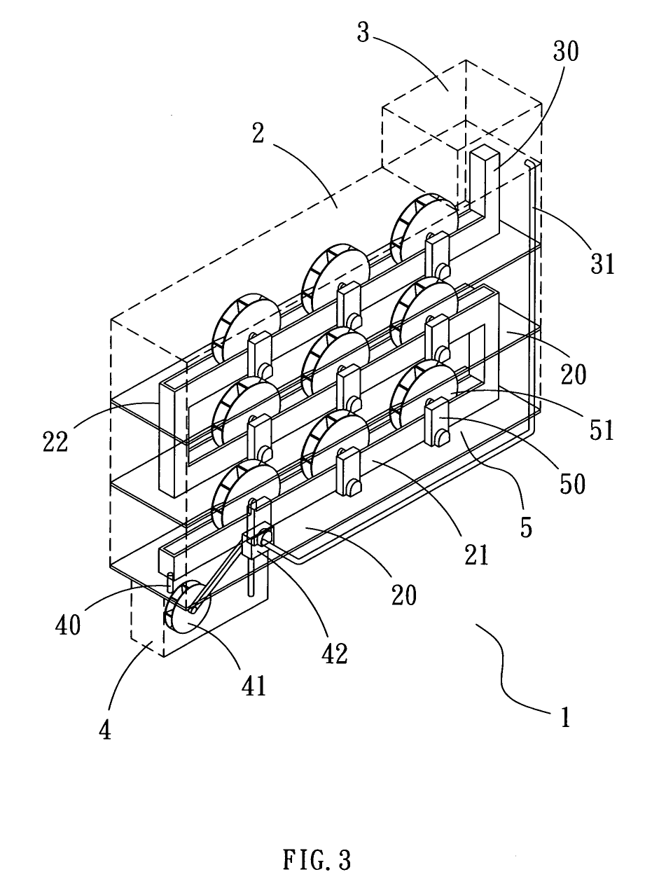

Seeing FIG. 3, in a third preferred embodiment of the present invention, a circulating hydroelectricity generating and energy storing apparatus 1 comprises a carrier 2, a water-supply tank 3, a water-storage tank 4 and a hydroelectric device 5.

The carrier 2 is hollow and has one or more carrying boards 20 settled above a bottom thereof. Draining channels 21 are arranged on bottoms of the carrying boards 20 and the bottom of the carrier 2. The draining channels 21 on the different carrying boards 20 are connected by a plurality of connecting pipes 22. The carrier 2 may be any one of an apartment, a mansion, a building, a concrete construction and a reinforced concrete construction.

The water-supply tank 3 accommodates therein a fluid, such as water, and has an outlet 30 and an inlet 31 for draining and filling water, respectively.

The water-storage tank 4 also accommodates therein a fluid, such as water, and has an inlet 40 for filling water. Furthermore, the water-storage tank 4 is provided pivotally with a first waterwheel 41 that drives a water pump 42 for drawing the water in the water-storage tank 4 outward. The first waterwheel 41 and the water pump 42 may be dynamically linked by any one of a chain assembly, a gear assembly, a rotational axle assembly and a pulley assembly.

The hydroelectric device 5 is composed of a plurality of generators 50, each provided pivotally with a second waterwheel 51 that rotates to enable the corresponding generator 50 to generate electricity.

To assemble the above-recited components, the water-supply tank 3 is settled at a top of the carrier 2 while the water-storage tank 4 is settled at the bottom of the carrier 2. The draining channels 21 on the carrying boards 20 are connected by the connecting pipes 22. The uppermost draining channel 21 is connected with the outlet 30 of the water-supply tank 3 while the lowermost draining channel 21 is connected with the inlet 40 of the water-storage tank 4. Meanwhile, the water pump 42 of the water-storage tank 4 is in connection with the inlet 31 of the water-supply tank 3.

In addition, the generators 50 of the hydroelectric device 5 are arranged beside and along the draining channels 21. Each said generator 50 has a second waterwheel 51 with a bottom thereof received in the corresponding draining channel 21. When the above-recited components are assembled and in operation, the water in the water-supply tank 3 flows into the uppermost draining channel 21 through the outlet 30, and the water flowing in the uppermost draining channel 21 drives the corresponding second waterwheels 51 to rotate, so that the rotating second waterwheels 51 enable the corresponding generators 50 to generate electricity. Afterward, the water keeps flowing toward the draining channels 21 on lower said carrying boards 20 through the connecting pipes 22 and successively rotates the corresponding second waterwheels 51, so as to enable the corresponding generators 50 to generate electricity. Eventually, when water in the lowermost draining channel 21 enters the water-storage tank 4 through the inlet 40, the water impacts and rotates the first waterwheel 41. The rotating first waterwheel 41 drives the water pump 42 to draw water in the water-storage tank 4 back to the water-supply tank 3 through the inlet 31, thereby recycling the water used in power generation.

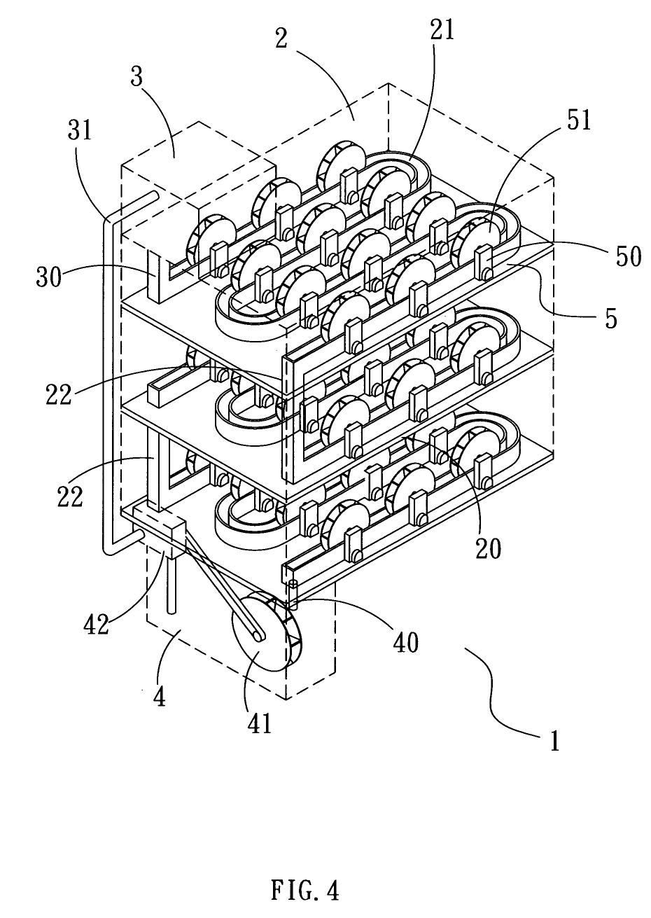

FIG. 4 depicts a fourth preferred embodiment of the present invention. As can be seen clearly in the drawing, a circulating hydroelectricity generating and energy storing apparatus 1 comprises a carrier 2, a water-supply tank 3, a water-storage tank 4 and a hydroelectric device 5. The water-supply tank 3 is settled at a top of the carrier 2 while the water-storage tank 4 is settled at a bottom of the carrier 2. The carrier 2 has one or more carrying boards 20 arranged above the bottom thereof. Serpentine draining channels 21 are disposed on the carrying boards 20 and the bottom of the carrier 2. The draining channels 21 on the different carrying boards 20 are connected by a plurality of connecting pipes 22. The uppermost serpentine draining channel 21 is connected with an outlet 30 of the water-supply tank 3 while the lowermost serpentine draining channel 21 is connected with an inlet 40 of the water-storage tank 4. Furthermore, the water-storage tank 4 is provided pivotally with a first waterwheel 41 that drives a water pump 42, wherein the water pump 42 is in connection with an inlet 31 of the water-supply tank 3.

In addition, the hydroelectric device 5 is composed of a plurality of generators 50 that are arranged beside and along the serpentine draining channels 21. Each said generator 50 is provided pivotally with a second waterwheel 51 that has a bottom thereof received in the corresponding draining channel 21.

The carrier 2 may be any one of an apartment, a mansion, a building, a concrete construction and a reinforced concrete construction while the first waterwheel 41 and the water pump 42 may be dynamically linked by any one of a chain assembly, a gear assembly, a rotational axle assembly and a pulley assembly.

When the above-recited components are assembled and in operation, water in the water-supply tank 3 flows into the uppermost draining channel 21 through the outlet 30, and the water flowing in the uppermost draining channel 21 drives the corresponding second waterwheels 51 to rotate, so that the rotating second waterwheels 51 enable the corresponding generators 50 to generate electricity. Afterward, the water keeps flowing forward to the draining channels 21 on lower said carrying boards 20 through the connecting pipes 22 and successively drives the corresponding second waterwheels 51, so as to enable the corresponding generators 50 to generate electricity. Eventually, when water passing through the lowermost draining channel 21 enters the water-storage tank 4 through the inlet 40, the water impacts and rotates the first waterwheel 41. The rotating first waterwheel 41 drives the water pump 42 to draw water in the water-storage tank 4 back to the water-supply tank 3 through the inlet 31, thereby recycling the water used in power generation.

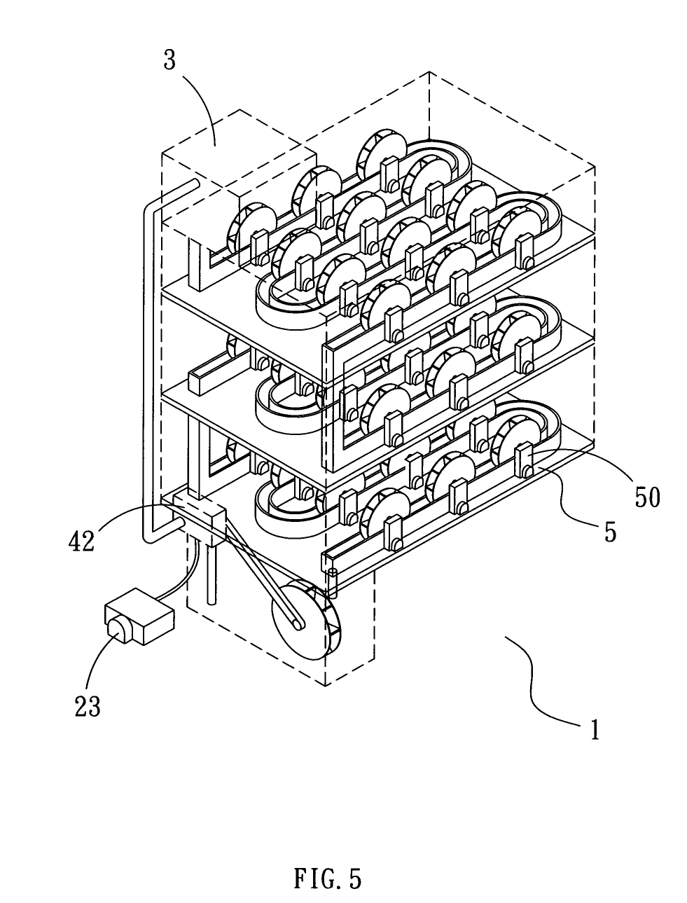

FIG. 5 further shows a fifth preferred embodiment of the present invention. Therein, a circulating hydroelectricity generating and energy storing apparatus 1 similar to its counterparts described in the previous preferred embodiments is additionally equipped with an external generator 23. In operation, electricity generated by the external generator 23 is supplied to a water pump 42 of the circulating hydroelectricity generating and energy storing apparatus 1 so that the water pump 42, which is supplied with more electricity, is enabled to operate more efficiently, thereby accelerating recycle of the water used in power generation. The external generator 23 may be any one of a wind power generator, a diesel generator, a thermal power generator and a solar power generator. Alternatively, part of the electricity generated by a plurality of generators 50 of a hydroelectric device 5 provided in the circulating hydroelectricity generating and energy storing apparatus 1 may be supplied to the external generator 23 or the water pump 42. Thereby, when the external generator 23 is in operation, water can be drawn back to the water-supply tank 3 more promptly. Hence, unstable power sources such as wind power and solar energy can be stored in the water-supply tank 3 in the form of water-level difference for later use, and the function of energy storage is accomplished by the circulating hydroelectricity generating and energy storing apparatus 1.

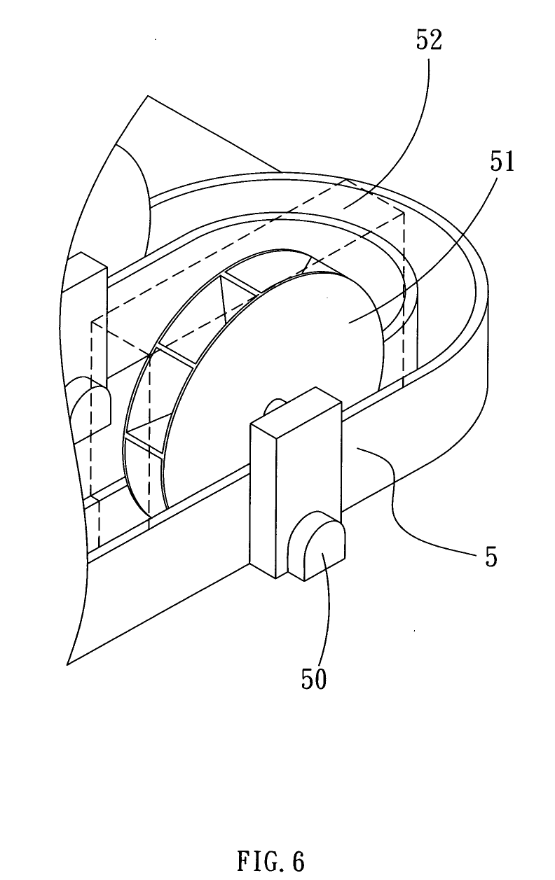

Referring to FIGS. 1 and 6, according to the drawings, the circulating hydroelectricity generating and energy storing apparatus 1 of the present invention may further comprise a plurality of shells 52, each covering one of the second waterwheels 51 and forming a closed room with the draining channel 21, so as to protect water in the draining channel 21 from being polluted by dust or dirt, thereby maintaining the cleanness of the circulating hydroelectricity generating and energy storing apparatus 1 and prolonging the recycling life of water used in power generation.

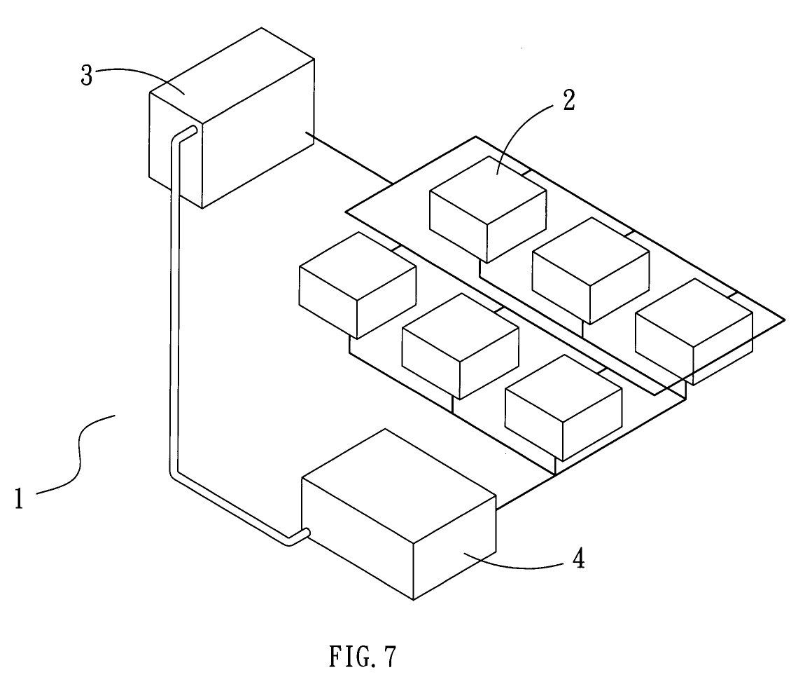

FIG. 7 is a schematic drawing showing an application of the present invention. As can be seen, the disclosed circulating hydroelectricity generating and energy storing apparatus 1 may be deployed over plural said carriers 2 that share a single set of said water-supply tank 3 and water-storage tank 4. Therefore, the disclosed subject matter can be preset during construction of collective housings for later operation.

The present invention has been described with reference to preferred embodiments thereof, which are provided for illustrative purposes only and not intended to limit the scope of the present invention. Therefore, all simple modifications and equivalent structural changes based on the contents disclosed herein and the accompanying drawings should be encompassed by the appended claims.

1. A circulating hydroelectricity generating and energy storing apparatus, comprising:
a carrier, having a draining channel settled on a bottom thereof;
a water-supply tank, settled at a top of the carrier while having an outlet connected with the draining channel and an inlet for allowing water to flow into the water-supply tank;
a water-storage tank, settled at the bottom of the carrier while having an inlet connected with the draining channel and a first waterwheel pivotally installed in the water-storage tank, wherein the first waterwheel drives a water pump to draw water in the water-storage tank to the inlet of the water-supply tank; and a hydroelectric device, comprising at least one generator positioned beside the draining channel, wherein the generator is pivotally equipped with a second waterwheel that has a bottom thereof received in the draining channel.

2. A circulating hydroelectricity generating and energy storing apparatus, comprising:
a carrier, having one or more carrying boards settled above a bottom thereof, wherein draining channels are settled on the carrying boards and the bottom of the carrier;
a water-supply tank, settled at a top of the carrier and having an outlet connected with an uppermost one of the draining channels in the carrier and an inlet for allowing water to flow into the water-supply tank;
a water-storage tank, settled at the bottom of the carrier while having an inlet connected with a lowermost one of the draining channels in the carrier and a first waterwheel pivotally installed in the water-storage tank, wherein the first waterwheel drives a water pump to draw water in the water-storage tank to the inlet of the water-supply tank; and a hydroelectric device, comprising a plurality of generators positioned beside and along the draining channels, wherein each of the generators is pivotally equipped with a second waterwheel that has a bottom thereof received in a corresponding one of the draining channels.

3. The circulating hydroelectricity generating and energy storing apparatus of claim 1, wherein an external generator is further provided at the top of the carrier and has electricity generated therefrom supplied to the water pump.

4. The circulating hydroelectricity generating and energy storing apparatus of claim 3, wherein the external generator is one of a wind power generator, a diesel generator, a thermal power generator and a solar power generator, or a part of electricity generated by the generator of the hydroelectric device is supplied to the external generator or the water pump, so that when the external generator is in operation, the water in the water-storage tank is drawn back to the water-supply tank for achieving functions of energy storage and water circulation.

5. The circulating hydroelectricity generating and energy storing apparatus of claim 1, wherein each of the second waterwheels is covered by a shell.

6. The circulating hydroelectricity generating and energy storing apparatus of claim 1, wherein the first waterwheel and the water pump are dynamically linked by one of a chain assembly, a gear assembly, a rotational axle assembly and a pulley assembly.

7. The circulating hydroelectricity generating and energy storing apparatus of claim 2, wherein the draining channels on the carrying boards are connected by connecting pipes.

8. The circulating hydroelectricity generating and energy storing apparatus of claim 3, wherein the external generator is one of a wind power generator, a solar power generator, a diesel generator, a thermal power generator and a combination thereof.

9. The circulating hydroelectricity generating and energy storing apparatus of claim 1, wherein the carrier is a mobile carrier.

10. The circulating hydroelectricity generating and energy storing apparatus of claim 2, wherein third waterwheels are provided at water-falling points of the draining channels on the carrying boards and on the bottom of the carrier.

11. The circulating hydroelectricity generating and energy storing apparatus of claim 1, wherein the draining channel is sloped to increase a momentum of the water.

12. The circulating hydroelectricity generating and energy storing apparatus of claim 1, wherein the circulating hydroelectricity generating and energy storing apparatus is deployed over plural said carriers that share a single set of said water-supply tank and water-storage tank and is preset during construction of collective housings.

13. The circulating hydroelectricity generating and energy storing apparatus of claim 2, wherein an external generator is further provided at the top of the carrier and has electricity generated therefrom supplied to the water pump.

14. The circulating hydroelectricity generating and energy storing apparatus of claim 2, wherein each of the second waterwheels is covered by a shelll.

15. The circulating hydroelectricity generating and energy storing apparatus of claim 2, wherein the first waterwheel and the water pump are dynamically linked by one of a chain assembly, a gear assembly, a rotational axle assembly and a pulley assembly.
